(19) United States
(12) Patent Application Publication
(10) Pub. No.: US 2003/0223132 A1
(43) Pub. Date: Dec. 4, 2003

(54) Method and device for variably attenuating the intensity of a light beam

(76) Inventor: Wolfgang Seifert, Aalen (DE)

Correspondence Address: HARNESS, DICKEY & PIERCE, P.L.C., P.O. BOX 828, BLOOMFIELD HILLS, MI, 48303, US

(21) Appl. No.: 10/436,525

(22) Filed: May 13, 2003

(30) Foreign Application Priority Data
May 13, 2002 (DE) 102 22 049.2

(51) Int. Cl. G02B 5/04

(52) U.S. Cl. 359/833

(57) ABSTRACT

The invention relates to a method for variably attenuating the intensity of the light beam, in the case of which method the light beam is directed onto at least one optical arrangement, that has at least one body transparent to the light beam, in such a way that the light beam enters the at least one body through a light incidence surface and emerges again from the at least one body through a light emergent surface, the at least one body being moved in position relative to the incident light beam, in order to change the intensity of the emergent light beam with reference to the intensity of the incident light beam. It is proposed that the light beam be allowed to be incident, in the at least one body between the light incidence surface and the light emergent surface, on at least one interface to an optically thinner medium, the at least one body being moved in position relative to the incident light beam such that the incidence angle of the light beam on the interface is set to an angle that is smaller or greater than or equal to the critical angle of total reflection at this interface. Furthermore, a device is described for carrying out the method, in particular.

### CROSS REFERENCE TO FOREIGN APPLICATION

The present application claims priority of German patent application DE 102 22 049.2 filed on May 13, 2002, which is incorporated herein by reference.

### BACKGROUND OF THE INVENTION

The invention relates to a method for variably attenuating the intensity I₀ of a light beam, in the case of which method the light beam is directed onto at least one optical arrangement, that has at least one body transparent to the light beam, in such a way that the light beam enters the at least one body through a light incidence surface and emerges again from the at least one body through a light emergent surface, the at least one body being moved in position relative to the incident light beam, in order to change the intensity Iₐ of the emergent light beam with reference to the intensity I₀ of the incident light beam.

The invention also relates to a device for variably attenuating the intensity of a light beam having an optical arrangement that has at least one body that is transparent to the light beam and has a light incidence surface and a light emergent surface, and it being possible for the at least one body to be moved in position relative to the incident light beam in order to change the intensity of the emergent light beam with reference to the intensity of the incident light beam.

Such a method and such a device are required, for example, in the fabrication of semiconductor chips, in the case of which fabrication a light beam that is generated by an excimer laser, in particular, is used for patterning the semiconductor chip to be fabricated. During the patterning of semiconductor chips with the aid of light, it is desirable that the light used for patterning the semiconductor chips has an intensity which is constant over the lifetime of the system as a whole. Since the power can change in the system as a whole because of degradation processes, a variable attenuator is required in order to keep the power constant. The attenuation is performed by means of a device of the type mentioned at the beginning, which is also denoted as an optical attenuator. If losses occur in the intensity of the light generated by the laser, for example as a consequence of aging of the optical components of the laser, the degree of attenuation of the intensity is reduced in order to maintain a constant intensity of the light.

It is conceivable in principle to attenuate the intensity of the light by partial absorption in an absorber material. An attenuation of the intensity of the light by absorption has the disadvantage, however, that the absorber material is strongly heated, particularly in the case of laser light of high intensity, and the optical properties of the absorber material are a function of the temperature and thus of the degree of variable attenuation. The optical attenuators should be resistant to radiation, in particular because the powers of the currently available lasers are high and the powers of future lasers will rise even further.

U.S. Pat. No. 4,398,806 discloses an optical arrangement that has four transparent bodies in the form of wedge plates. The light beam coming from the light source passes through all four wedge plates one after another. Each wedge plate has a light incidence surface and a light emergent surface, the light beam running between these two surfaces without further beam deflection. All four wedge plates are inclined and can be rotated with reference to the respectively incident light beam, in order to effect an attenuation of the incident light beam by Fresnel reflections of different strength at the respective light incidence surface and light emergent surface of the respective wedge plate.

The method described there for attenuating the light beam accordingly consists in changing the reflection at least one of the light incidence surfaces by moving the position of the wedge plates, that is to say by reflecting away a fraction, greater or smaller depending on circumstances, of the incident light at the light incidence surface. Accordingly, the principle of this method is based on reducing the transmission of the light beam through the four wedge plates by an adjustable reflection of the light beam at the light incidence surface of at least one of the wedge plates, in order to achieve the desired attenuation, the attenuation being minimal when the light beam strikes the interface at the Brewster angle.

The disadvantage of this device and this method consists in that, given strong attenuation, the light beam emerges virtually in a grazing fashion from two of the four wedge plates, and this places very stringent requirements on the position of the mechanical construction. Because of the grazing emergence, it is required to ensure that the light beam is not lost between two wedge plates as a stray beam. Moreover, the maximum attenuation of the light beam is limited by means of this known optical attenuator. In order to avoid a deflection dependent on the wavelength and on the degree of the attenuation, or to avoid an offset, dependent on the wavelength and on the degree of attenuation, of the incident light beam, there is a need for four wedge plates that must be rotated in a precisely synchronous fashion.

Furthermore, there is known from JP 05 002 141 A an optical attenuator for laser light that has a right-angled isosceles prism, the light beam to be attenuated being incident on a short face of the prism, being totally reflected at the hypotenuse, and emerging again from the prism through the other short face at a right angle to the incident light beam. A plate with a high refractive index is joined to the hypotenuse of the prism with a spacing of a minimal air gap. The plate can be finely adjusted via a piezoelectric actuator in order to vary the gap between the plate and the hypotenuse of the prism. Use is made in this known device and this known method of the so-called optical tunnel effect, in accordance with which a light beam totally reflected at an interface also enters the optically thinner medium. However, since this effect is limited to a few wavelengths of the light, this known method and this known device have the disadvantage that such a mechanical fine adjustment of the plate to the order of magnitude of a few wavelengths of the light used is very complicated.

It is the object of the invention to develop a method and a device of the type mentioned at the beginning to the effect that a variably adjustable attenuation is rendered possible for intensive laser radiation, in particular, with a mechanical outlay that is as low as possible.

### SUMMARY OF THE INVENTION

According to the invention, a method for variably attenuating the intensity of a light beam is provided, comprising the steps of:

directing said light beam onto at least one optical arrangement having at least one body transparent to said light beam, such that said light beam enters said at least one body through a light incidence surface of said body and emerges again from said at least one body through a light emergent surface of said body,

moving said at least one body in position relative to said light beam entering said at least one body through said light incidence surface, in order to change the intensity of said light beam emerging through said light emergent surface with reference to said light beam entering said at least one body through said light incidence surface,

wherein said light beam is allowed to be incident in said at least one body between said light incidence surface and said light emergent surface on at least one interface to an optically thinner medium, said at least one body being moved in position relative to said light beam entering through said light incident surface such that an incident angle of said light beam on said interface is set to an angle that is smaller or greater than or equal to the critical angle of total reflection at said interface.

Further, according to the invention, a device for variably attenuating the intensity of a light beam is provided, comprising:

an optical arrangement having at least one body that is transparent to said light beam,

said at least one body having a light incidence surface and a light emergent surface,

said at least one body being movable in position relative to said light beam entering through said light incidence surface in order to change the intensity of said light beam emerging from said light emergent surface with reference to the intensity of said light beam entering through said light incidence surface,

wherein, apart from said light incidence surface and said light emergent surface, said at least one body has at least one interface to an optically thinner medium, it being possible for said at least one body to be moved in position such that an incident angle of said light beam on said interface to be set to an angle that is smaller or greater than or equal to the critical angle of total reflection at said interface.

The method according to the invention and the device according to the invention are based on a different concept by comparison with the prior art. Instead, as in the case of the known device and the known method, of maximizing the transmission through the at least one body by virtue of the fact that the light beam strikes the interface at the Brewster angle, and by selecting the incidence angle to be different from the Brewster angle, in order to obtain the desired attenuation by having the unused fraction of the light beam reflected, the approach of the method according to the invention and of the device according to the invention is to effect an attenuation by reducing the reflection at the interface between the light incidence surface and the light emergent surface of the at least one body, the unused fraction of the light beam being transmitted. If the at least one body is set relative to the incident light beam such that the light beam is incident on the interface below an incidence angle that is greater than or equal to the critical angle of total reflection, no attenuation of intensity of the light beam occurs (apart from negligible absorption losses upon passage through the body, and reflection losses at the light incidence surface because of the reflectivity of the body, it being possible for the latter to be virtually excluded by a suitable antireflection coating on the light incidence surface, or by a configuration of the shape of the body in such a way that, in the case of minimal attenuation, the light beam strikes the light entry surface or light emergent surface at the Brewster angle). If the at least one body is moved in position relative to the incident light beam such that the light beam is incident on the interface at an incidence angle φₑ that is smaller than the critical angle φ_{g} of total reflection, the light beam is partially refracted at this interface into the optical thinner medium, and the fraction of the light intensity reduced by the refracted fraction is reflected at the interface and emerges from the light emergent surface. The attenuation of the intensity of the light beam is thereby achieved essentially by a refraction of the light beam at the interface. The attenuation is variably adjustable in this case, that is to say an increasing fraction of the intensity of the light beam is reflected at the interface with reducing incidence angle φₑ of the light beam at the interface.

The advantage of the method according to the invention and the device according to the invention consists in that the at least one body can be a prism of which it is possible to make use, for example, of one surface as the abovementioned interface at which total reflection or partial reflection and refraction can optionally occur. Such an optical body can also be positioned with low mechanical outlay and can, in particular, be moved in position with reference to the incident light beam. It can, in particular, be positioned such that both a grazing light incidence and a grazing light emergence of the beam used are avoided. Since the beam used is reflected and the angle of reflection of the reflected beam is not subject to dispersion, chromatic aberrations are smaller in the case of the method according to the invention and of the device according to the invention than in the case of the method and the device in accordance with document U.S. Pat. No. 4,398,806.

In a preferred refinement of the method, the at least one body is moved in position relative to the incident light beam such that the incidence angle φₑ of the light beam on the interface is set to an angle in the range of from 0° up to the critical angle φ_{g} of total reflection.

In a correspondingly preferred refinement of the device, the at least one body is assigned an actuator that permits a movement in position of the at least one body in such a way that the light beam can be incident on the interface at an incidence angle φₑ in the range of between 0° and the critical angle φ_{g} of total reflection.

It is advantageous in this case that it is possible completely to utilize the range of the attenuation possible overall between a substantially vanishing attenuation (total reflection at the interface) and a maximal attenuation.

In a further preferred refinement of the method, the light beam is allowed to be incident on the interface as a light beam polarized linearly in the incidence plane, and the body is moved in position relative to the incident light beam such that the incidence angle on the interface is set to an angle in the range of from the critical angle φ_{g} of total reflection to the Brewster angle φₚ at this interface.

It is of particular advantage in this case that an attenuation of the intensity of the light beam can be variably set over a total range of from virtually 0% to 100%. Use is made in this case of the physical law that light linearly polarized in the incidence plane is not reflected at an interface when it is incident on the interface at the Brewster angle φₚ. Moreover, the advantage is achieved that the range of the movement in position of the at least one body can be limited to a small adjustment path, since the Brewster angle is only approximately 10° distant from the critical angle of total reflection, for example in the case of a glass/air transition. It is thereby possible for the body to be positioned, given an appropriately selected geometry, such that incident and emergent light beams are substantially perpendicular to the light entry surface and light emergent surface, respectively.

It is preferred here, in the case of the device according to the invention, when connected upstream of the at least one body is a polarizer or an element for rotating the polarization plane, which linearly polarizes the incident light beam parallel to the incidence plane.

If use is made of a light source whose light is not linearly polarized, or whose light is polarized in a plane inclined to the incidence plane, this measure has the advantage of ensuring that, as previously described, the light beam can be incident on the interface as light polarized linearly in the incidence plane. A λ/2 plate, for example, can be used as element for rotating the polarization plane.

In a further preferred refinement of the method, the at least one body is moved in position such that the light beam emerging from the light emergent surface does not vary, or scarcely varies, its spatial position relative to the incident light beam.

This measure has the advantage that, when a desired degree of attenuation is being set, the position of the emergent light beam relative to the incident light beam does not vary, without this requiring additional optical components that also need to be adjusted when moving the position of at least one body. The device according to the invention can be constructed very cost effectively in this way.

It is possible in this case to provide in a preferred refinement that the least one body is swiveled about an axis of rotation running transverse to the incidence plane, and is displaced transverse to this axis of rotation in a translatory fashion, in order to achieve the previously mentioned spatially invariance of the emergent light beam with reference to the incident light beam.

It is accordingly preferred in this case when the at least one body can be rotated about an axis of rotation running transverse to the incidence plane of the light beam, and can be moved in a translatory fashion.

However, it is particularly preferred when, in the case of the method according to the invention, the at least one body is rotated exclusively about an axis of rotation running transverse to the incidence plane and selected such that the light beam emerging from the light emergent surface does not vary its spatial position relative to the incident light beam.

In the case of the device according to the invention, it is preferably provided for this purpose that the at least one body can be rotated about an axis of rotation which runs transverse to the incidence plane and is selected such that the light beam emerging from the light emergent surface does not change its spatial position relative to the incident light beam.

This measure has the advantage that the actuator can be configured as a pure rotary drive, that is to say that it is possible to dispense with a more complicated actuator that is capable of effecting both a rotation and a translatory movement of the at least one body. This refinement proceeds from the basic idea that every movement of a body that is composed of a rotation about an axis of rotation and a translatory movement can be implemented by a rotation about an appropriately selected axis of rotation.

In addition, it can likewise be preferred when the light beam emerging from the light emergent surface is corrected by means of a further optical body with reference to the incident light beam as a function of the movement in position of the first body with reference to its position and/or with reference to the symmetry of the attenuation of the light beam.

This can be implemented, for example, by virtue of the fact that there is connected downstream of the at least one body, which is used to change the intensity of the light beam, a further body in the form of a deflecting prism, a mirror or the like that is then appropriately positioned as a function of the movement in position of the at least one first body in order to maintain an unchanged spatial position of the emergent light beam with reference to the incident light beam, or in order to achieve the advantage that a light beam with finite divergence is symmetrically attenuated.

In a further preferred refinement of the device, the at least one body is a prism.

A prism constitutes an optical element of simple design that is particularly suitable for the present invention.

It is particularly preferred in this case when the at least one body is a prism of constant deflection.

A prism of constant deflection can be used to implement in a particularly simple way in terms of design a device in accordance with one of the previously mentioned refinements in order to achieve that during the movement in position of the at least one body the light beam emerging from the light emergent surface does not vary, or scarcely varies its spatial position with reference to the incident light beam.

In a further preferred refinement, the at least one body is a right-angled prism, preferably a right-angled isosceles prism.

The use of such a prism for the present invention has the advantage that such a prism on the one hand constitutes a prism of constant deflection in the case of which, given an appropriate selection of the axis of rotation, the spatial position of the light beam emerging from the light emergent surface does not change with reference to the incident light beam, and that the device according to the invention and the method according to the invention can be implemented with the aid of only one prism.

In a further preferred refinement, a material with a refractive index of greater than or equal to 2^{0.5} is preferably used for a right-angled, in particular a right-angled isosceles prism of the refinement previously mentioned.

Given this selection of the material for the at least one prism, the critical angle φ_{g} of total reflection is smaller than or equal to 45°. In this way, such a prism can be positioned particularly advantageously for the purposes of the invention such that the light beam is incident perpendicularly on the hypotenuse of the prism and emerges from the latter again in a fashion offset in parallel (—that is to say the light entry surface and light emergent surface coincide), when no attenuation of the intensity of the light beam is desired, and that, with reference to the incident light beam, the prism need be set inclined only by an angle in a small angular range in order to set the desired intensity la of the emergent light beam; in particular, when the procedure follows one of the previously mentioned refinements, specifically when the incidence angle of the light beam on the interface is varied between the Brewster angle and the critical angle of total reflection, which can also be exceeded. A grazing light incidence or light emergence is thereby avoided.

In a further preferred refinement, the light incidence surface is provided with an antireflection coating or antireflection microstructuring, or it exhibits shaping of such a type that it is arranged at the Brewster angle relative to the incident light beam.

It is possible with the aid of such refinements to minimize light losses at the light incidence surface, and on the other hand it is possible to avoid interfering retroreflections, particularly in the case of perpendicular incidence of light beam on the light incidence surface.

In a further preferred refinement, the interface is provided with a coating or microstructuring for modifying the course of the curve of the reflection coefficient R as a function of the incidence angle at the interface.

The advantage of this measure consists in that, for example, the reflection coefficient R_{⊥}for light linearly polarized perpendicularly in the incidence plane, which is always nonvanishing in the absence of such a coating or microstructuring, can be set close to or equal to zero for defined incidence angles φₑ, for example for φₑ=0°. As a result, the advantage is achieved that it is possible, for example, to work with light linearly polarized perpendicularly in the incidence plane, and that in this case it is possible to utilize the entire range of incidence angles from 0° up to the critical angle φ_{g} of total reflection. Moreover, the modification can also consist in giving the curve of the reflection coefficient, which always becomes very steep toward the critical angle φ_{g} of total reflection, a flatter shape, in order to reduce the gradient of the attenuation as a function of the movement in the position of the body. An antireflection coating can likewise be provided here as the coating, while a microstructuring of the interface can be implemented by optical gratings, for example, with or without an antireflection action.

In a further preferred refinement, the at least one body consists of calcium fluoride.

Calcium fluoride has the advantage that it has a refractive index of greater than 2^{0.5} for the laser wavelengths of 248 nm, 193 nm and 157 nm, and is therefore suitable as material for the previously named right-angled isosceles prism for perpendicular incidence of excimer laser light through the hypotenuse and total reflection given an incidence angle of 45° of the light beam on the interface.

However, it goes without saying that instead of a right-angled or even an isosceles right-angled prism it is also possible to use other prisms of constant deflection for the present invention, for example pentaprisms, Wollaston prisms, Bauernfeind prisms, or else an arrangement according to Löwe composed of two Bauernfeind prisms that can be oppositely rotated, or an arrangement of a plurality of such prisms. It goes without saying, furthermore, that, as already mentioned, in the case of a use of such a prism, the light incidence surface and the light emergent surface can be formed by the same interface of the prism, and that the at least one body can have further interfaces at which the light beam is totally reflected, or only partially reflected by variation of the incidence angle.

Further advantages and features emerge from the following description and the attached drawing.

It goes without saying that the features named above and those still to be explained below can be used not only in the respectively specified combination, but also in other combinations or standing on their own, without departing from the scope of the present invention.

### BRIEF DESCRIPTION OF THE DRAWINGS

Exemplary embodiments of the invention are illustrated in the drawing, and are described in more detail hereunder with reference to said drawing, in which:

FIG. 1 shows a schematic of a device for variably attenuating the intensity of a light beam, in side view in a first operating position;

FIG. 2 shows the device in FIG. 1, in a second operating position;

FIG. 3 shows the device in FIGS. 1 and 2, in a third operating position;

FIG. 4 shows a combined illustration of two operating positions of the device in FIGS. 1 and 3;

FIG. 5 shows an optical arrangement for use in the device in FIG. 1, in accordance with a further exemplary embodiment;

FIG. 6 shows an optical arrangement for use in the device in FIG. 1, in accordance with a yet further exemplary embodiment; and

FIG. 7 shows a diagram in which the reflection coefficient R is illustrated as a function of the incidence angle φₑ of the light beam in the case of a transition of an optically denser medium into an optically thinner medium.

### DETAILED DESCRIPTION OF PREFERRED EMBODIMENTS

A device, provided with the general reference numeral 10, for variably attenuating the intensity of a light beam 12 is illustrated schematically in FIGS. 1 to 4.

The light beam 12 is a laser light beam that has been generated, for example, by an excimer laser.

The device 10 has an optical arrangement 14 that has at least one body 16 that is transparent to the light beam 12.

The body 16 is a prism 18 of constant deflection that in the present exemplary embodiment is a right-angled isosceles prism.

The body 16 has a light incidence surface 20 through which the incident light beam 12e enters the body 16, and a light emergent surface 22, through which the attenuated light beam 12a, which is also denoted below as emergent light beam, emerges from the body 16 again. In the exemplary embodiment shown, the light incidence surface 20 and the light emergent surface 22 are formed by the same surface of the prism 18, specifically by its hypotenuse.

Between the light incidence surface 20 and the light emergent surface 22, the body 16 further has at least one interface 24 to an optically thinner medium 26, which can surround the body 16 entirely or else present only in the region of the interface 24. The interface 24 is formed by a short face of the prism 18. Furthermore, the body 16 has a second interface 28 toward the optically thinner medium 26.

The body 16 in the shape of the prism 18 has a material with the refractive index n₁. The optically thinner medium has the refractive index n₂. Snell's refractive law holds at the interface 24:

n₁ sin φₑ=n₂ sin φ_{d},

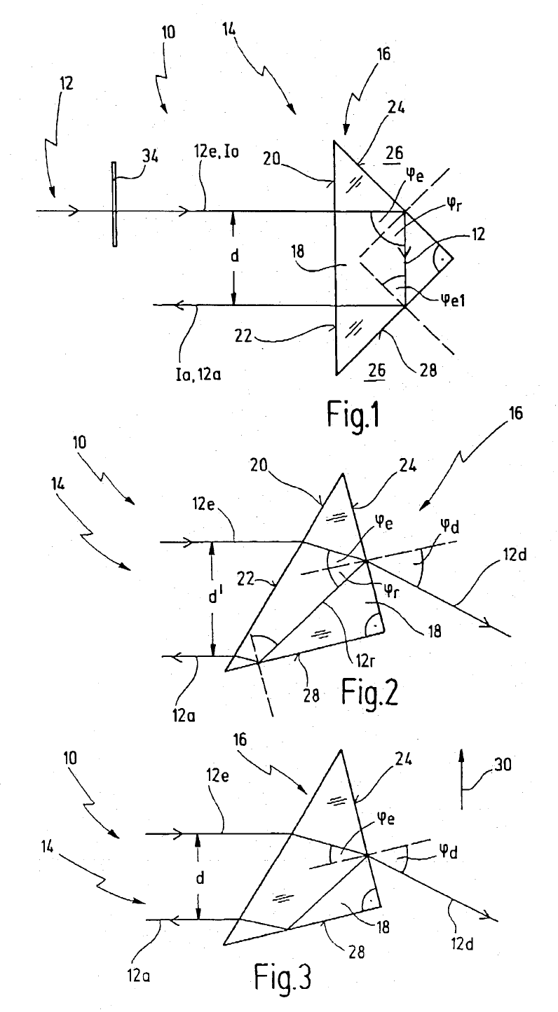

φₑ being the incidence angle of the light beam 12e on the interface 24, and φ_{g} being the refracting angle of the refracted light beam 12d upon transition of the light beam 12e into the optically thinner medium 26 (compare FIG. 2).

Total reflection of the light beam 12e occurs at the interface 24 when it holds that:

$$sin {ϕ}_{e} \geq \frac{{n}_{2}}{{n}_{1}} .$$

Assuming that the optically thinner medium 26 is air with a refractive index n₂=1, given the configuration with perpendicular light incidence onto the light incidence surface 20, and thus an incidence angle φₑ=45°, total reflection occurs when n₁≧2^{0.5}. The critical angle φ_{g} of total reflection at the interface 24 is 45° for the case of n₁=2^{0.5}.

It is preferably possible to select calcium fluoride as material for the body 16 that satisfies a condition n₁≧2^{0.5}, doing so for light wavelengths of 248 nm, 193 nm and 157 nm, which are wavelengths of an excimer laser.

It holds that φᵣ=φₑ, φᵣ being the angle of reflection, for the light beam 12r reflected at the interface 24. Because of the configuration of the prism 18 as a right-angled isosceles prism, in the case of perpendicular light incidence onto the light incidence surface 20, in accordance with FIG. 1, the light beam 12r reflected at the interface 24 is incident in turn at an incidence angle of 45° on the second interface 28 and is likewise totally reflected thereat.

In this case, the light beam 12a emerging from the light emergent surface 22 has an intensity Iₐ that is substantially unchanged by comparison with the intensity Iₒ of the incident light beam 12e, with the exception of reflection losses at the light incidence surface 20 and absorption losses in the body 16, which are negligible, however. In order to avoid such reflection losses and to avoid retroreflections, the light incidence surface 20 can be provided with an antireflection coating optimized, in particular, for perpendicular light incidence.

In order to effect an attenuation of the intensity Iₐ of the emerging light beam 12a with reference to the intensity Iₒ of the incident light beam 12e, the body 16 can be moved in position with reference to the incident light beam 12e, as illustrated in FIG. 2. For this purpose, the body 16 is assigned an actuator (not illustrated) that permits a movement in position of the body 16 with reference to the incident light beam 12e, whose position remains unchanged, such that the incident light beam 12e is incident on the interface 24 at an incidence angle φₑ<φ_{g}. Since the critical angle φ_{g} of total reflection is now undershot, a portion of the light beam 12e is refracted by the interface 24 into the optically thinner medium 26 as light beam 12d. A portion 12r of the incident light beam 12e continues, however, to be reflected at the interface 24, and to be totally reflected at the second interface 28, and then emerges as light beam 12a attenuated by the fraction of the light beam 12e passed through the interface 24 into the optically thinner medium 26. The intensity Iₐ of the emerging light beam 12a is thereby attenuated with reference to the intensity Iₒ of the incident light beam 12e. The refracted light beam 12d is rendered harmless by suitable means, while the light beam 12a serves as useful beam.

The actuator is preferably designed such that the body 16 can be moved in position with reference to the incident light beam 12e over a range in such a way that the incidence angle φₑ of the incident light beam 12e on the interface 24 can be set in the range of between close to 0° and the critical angle φ_{g} of total reflection.

It holds at the second interface 28 for the incidence angle φₑ₁ that the latter is always greater than the critical angle φ_{g} of total reflection when the incidence angle φₑ of the incident light beam 12e on the interface 24 is smaller than the critical angle φ_{g} of total reflection such that total reflection always occurs at the interface 28 under these conditions. However, it can also be considered to aluminize the interface 28, or to replace it with a mirror that is also moved.

However, the roles of the interfaces 24 and 28 can also be interchanged in the case of a reversed direction of rotation of the body 16, that is to say, by means of a movement in position of the body 16, a portion of the incident light beam 12e is passed at the interface 28 into the optically thinner medium 26, while there is always reflection at the interface 24.

When the light beam 12 is unpolarized, or at least not linearly polarized parallel to the incidence plane onto the interface 24, because of Fresnel's law of reflection it is not possible to achieve an attenuation of the light beam 12 by 100%, that is to say the emerging light beam 12a always has a finite intensity Iₐ, as also follows from FIG. 7, in which the reflection coefficient R is represented as a function of the incidence angle φₑ. To be precise, for the component of the light beam polarized perpendicular to the incidence plane, it holds even for an incidence angle φₑ=0° that a reflection occurs at the interface 24 that is determined by the reflectivity of the material of the body 16. This could be lowered to close to zero by an appropriate antireflection coating at the interface 24.

The curves for R_{⊥} and R_{∥} shown in FIG. 7 can be modified by a suitable coating, for example an antireflection coating, at the interface 24. For example, the coating can be such that R_{⊥}=0 for defined incidence angles φₑ with 0°<φₑ≦φ_{g}. Again, the curve for R_{⊥} or R_{∥} could thereby be flattened in the range φₚ≦φₑ≦φ_{g}.

In order to achieve an attenuation of the light beam 12 by even 100%, it is, however, possible to proceed such that the light beam 12e can be made to be incident at the interface 24 as light that is linearly polarized in the incidence plane. Specifically, as follows again from FIG. 7, there exists an angle φₚ, the so-called Brewster angle, at which light polarized linearly in a parallel fashion in the incidence plane is not reflected at the interface 24 when φₑ=φₚ. When, therefore, the light beam 12e is rendered incident on the interface 24 of the body 16 has light linearly polarized in the incidence plane, an adjustment of the incidence angle φₑ in a range α (compare FIG. 7) that corresponds to the difference between the critical angle φ_{g} of total reflection and the Brewster angle φₚ suffices for achieving an attenuation of the intensity Iₒ of the light beam 12 of approximately 0% (φₑ≧φ_{g}) and 100% (φₑ=φₚ).

If the light beam 12 is not in any case already linearly polarized in a fashion parallel to the incidence plane of the interface 24, the body 16 in accordance with FIG. 1 can be assigned a polarizer 34 that polarizes the light beam 12 linearly as appropriate. When the light beam 12 actually is linearly polarized, but in a plane that is not the incidence plane, it is possible, instead of the polarizer 34, to use an element for rotating the plane of polarization, for example a λ/2 plate.

With reference, again, to FIG. 2, it is illustrated there that the emerging light beam 12a attenuated in intensity with reference to the incident light beam 12e is offset parallel thereto, but that the offset d′ between the incident light beam 12e and the emerging light beam 12a is greater than the offset d in FIG. 1. The body 16 was rotated in this case from the position shown in FIG. 1 about the point of incidence of the incident light beam 12e on the interface 24, in order to set the incidence angle φₑ to the angle illustrated in FIG. 2.

In order to ensure that, when the position of the body 16 is moved in order to set the desired intensity of the light beam 12a, the emerging light beam 12a is not changed spatially with reference to the incident light beam 12e, in accordance with FIG. 3, the body 16 is moved in a translatory fashion in accordance with an arrow 30 in addition to the rotation about the axis of rotation running transversely to the incidence plane of the incident light beam 12e. During the translatory movement of the body 16 in the direction of the arrow 30, the incidence angle φₑ is not varied, but the offset d of the emerging light beam 12a is thereby produced again with reference to the incident light beam 12e in accordance with FIG. 1.

Instead of moving the position of the body 16 by superimposing or carrying out sequentially a rotation and a translatory movement, it is preferred exclusively to swivel the body 16 about an axis of rotation 32 that runs transverse to the incidence plane and is selected such that the emerging light beam 12a is not moved spatially in position with reference to the incident light beam 12e, as is illustrated in FIG. 4. FIG. 4 illustrates the transition of the position of the body 16 in FIG. 1 (continuous lines) to the position illustrated in FIG. 3 (broken lines), the positions in continuous lines and the position in broken lines having been slightly offset laterally to improve clarity. Given a rotation of the body 16 about the axis of rotation 32, that is situated in the exemplary embodiment shown on the middle perpendicular on the hypotenuse and at a spacing from the hypotenuse of approximately 0.33 times the length of the hypotenuse, in other words starting from the position of the body 16 illustrated by continuous lines, the position reached is not that illustrated by broken lines, but one that is offset downward to the right by comparison with the latter.

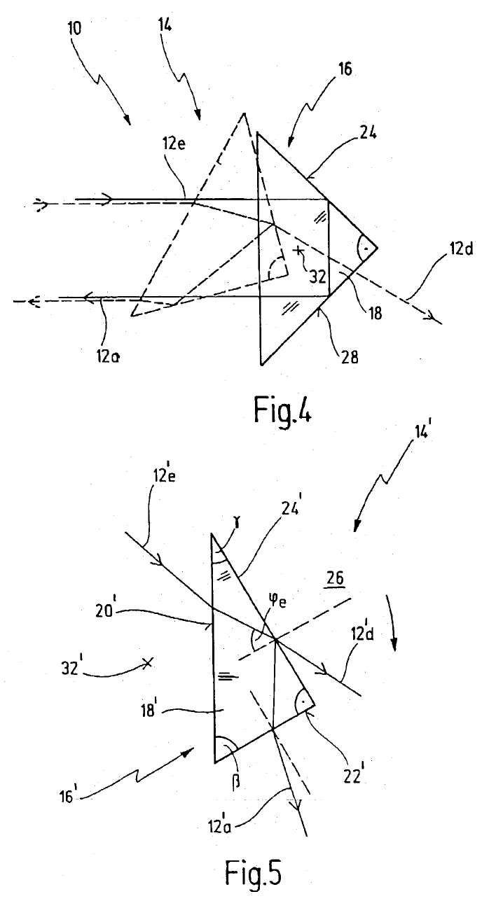

FIG. 5 illustrates a further exemplary embodiment of an optical arrangement 14′, having a body 16′, that can likewise be used in the device 10 for variably attenuating the intensity of the light beam 12. The body 16′ is, once again, a prism of constant deflection, specifically a so-called Bauernfeind prism that is a right-angled, but not an isosceles prism. The hypotenuse of the prism 18′ forms an angle β=60° with one short face, and an angle γ=30° with the other short face. This prism 18′ is used such that the light incidence surface 20′ is the hypotenuse of the prism 18′, and the light emergent surface 22′ is a short face. The other short face of the prism 18′ serves as the interface 24′ with the optically thinner medium 26′, at which total reflection or only partial reflection occurs depending on the setting of the incidence angle φₑ by movement in position of the body 16′ relative to the incident light beam 12e′.

The movement in position of the body 16′ is performed here about an axis of rotation 32′ that runs transverse to the incidence plane of the incident light beam 12e′ and is, again, selected such that the emerging light beam 12a′ does not vary its spatial position with reference to the incident light beam 12e′ in the case of the movement in position of the body 16′ in order to set the desired attenuation.

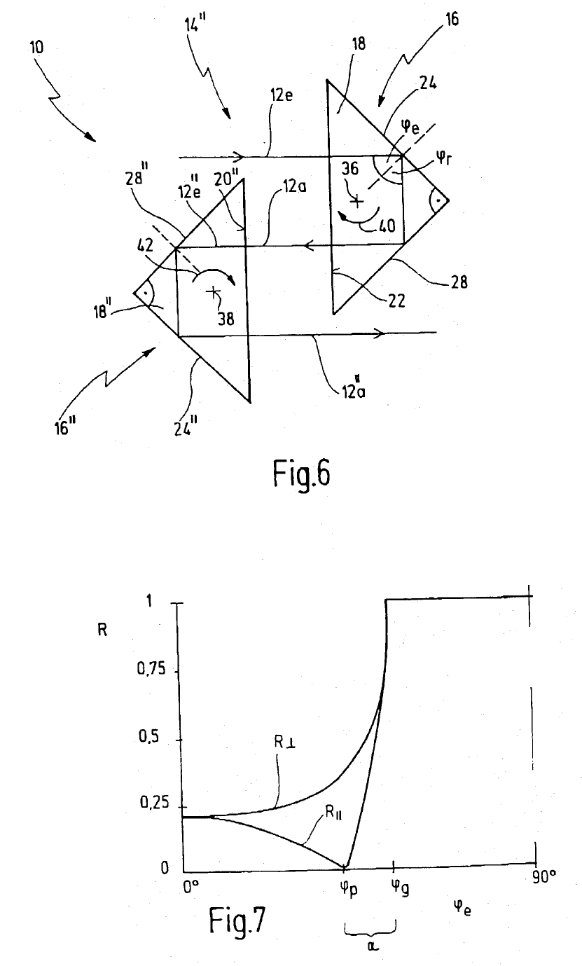

A further optical arrangement 14″ which can be used in the device 10 for variably attenuating the intensity of the light beam 12 is illustrated in FIG. 6. The optical arrangement 14″ has a first transparent body 16, which is identical to the transparent body 16 in FIGS. 1 to 4, and a second transparent body 16″, which is likewise formed by a right-angled isosceles prism 18″ that is arranged with its hypotenuse opposite and offset from the hypotenuse of the prism 18. The hypotenuses run parallel to one another in this case.

The light beam 12a emerging from the body 16 through the light emergent surface 22 simultaneously forms the incident light beam 12e″ that is incident in the body 16″ through the light entry surface 20″. The light beam emerging from the body 16″ is provided with the reference numeral 12a″.

The chief function of the body 16″ is to correct the position of the light beam 12a emerging from the first body 16 with reference to the incident light beam 12e as a function of the movement in position of the first body 16 such that the offset between the light beam 12e incident on the light incidence surface 20 and the light beam 12a″ remains constant independently of the movement in position of the body 16.

If, in accordance with FIG. 2, the body 16 is swiveled about the axis of rotation 36, and the body 16″ is swiveled about the axis of rotation 38 from the position illustrated in FIG. 6 in accordance with the arrows 40 and 42, the total reflection of the light beam 12e at the boundary surface 24 of the body 16, and the total reflection of the light beam 12e″ at the interface 24″ are interrupted such that the emerging light beam 12a has firstly experienced attenuation at the interface 24 and, as light beam 12e″, has experienced an additional attenuation at the interface 24″.

By suitable selection of the axes of rotation 36 and 38, it is possible to achieve that the light beam 12a″ emerging finally does not change its position with reference to the incident light beam 12e, and/or that the attenuation of a divergent light beam is performed symmetrically.

The second body could also be replaced by an appropriate mirror.

It goes without saying that other optical elements such as, for example, pentaprisms or Wollaston prisms can also be used in the present invention.

What is claimed is:

1. A method for variably attenuating the intensity of a light beam, comprising the steps of:
directing said light beam onto at least one optical arrangement having at least one body transparent to said light beam, such that said light beam enters said at least one body through a light incidence surface of said body and emerges again from said at least one body through a light emergent surface of said body,
moving said at least one body in position relative to said light beam entering said at least one body through said light incidence surface, in order to change the intensity of said light beam emerging through said light emergent surface with reference to said light beam entering said at least one body through said light incidence surface,
wherein said light beam is allowed to be incident in said at least one body between said light incidence surface and said light emergent surface on at least one interface to an optically thinner medium, said at least one body being moved in position relative to said light beam entering through said light incident surface such that an incident angle of said light beam on said interface is set to an angle that is smaller or greater than or equal to the critical angle of total reflection at said interface.

2. The method of claim 1, wherein said at least one body is moved in position relative to said light beam entering through said light incidence surface such that said incidence angle of said light beam on said interface is set to an angle in the range of from 0° to the critical angle of total reflection.

3. The method of claim 1, wherein said light beam is allowed to be incident on said interface as a light beam polarized linearly in the incidence plane, and wherein said body is moved in position relative to said light beam entering through said light incidence surface such that said incidence angle on said interface is set to an angle in the range of from said critical angle of total reflection to the Brewster angle at said interface.

4. The method of claim 1, wherein said at least one body is moved in position such that said light beam emerging from said light emergent surface does not vary, or scarcely varies, its spatial position relative to said light beam entering through said light incidence surface.

5. The method of claim 4, wherein said at least one body is swiveled about an axis of rotation running transverse to the incidence plane, and displaced in a translatory fashion transverse to said axis of rotation.

6. The method of claim 1, wherein said at least one body is moved in position such that said light beam emerging from said light emergent surface does not vary, or scarcely varies, its spatial position relative to said light beam entering through said light incidence surface, and wherein said at least one body is swiveled exclusively about an axis of rotation running transverse to the incidence plane and selected such that said light beam emerging from said light emergent surface does not vary its spatial position relative to said light beam entering through said light incidence surface.

7. The method of claim 1, wherein said light beam emerging from said light emergent surface is corrected by means of a further optical body with reference to said light beam entering through said light incidence surface as a function of the movement in position of said body with reference to at least one of a position and to a symmetry of the attenuation of said light beam.

8. The method of claim 1, wherein said at least one body is moved in position such that said light beam emerging from said light emergent surface does not vary, or scarcely varies, its spatial position relative to said light beam entering through said light incidence surface, and wherein a prism of constant deflection is used as said at least one body.

9. A device for variably attenuating the intensity of a light beam, comprising:
an optical arrangement having at least one body that is transparent to said light beam,
said at least one body having a light incidence surface and a light emergent surface,
said at least one body being movable in position relative to said light beam entering through said light incidence surface in order to change the intensity of said light beam emerging from said light emergent surface with reference to the intensity of said light beam entering through said light incidence surface,
wherein, apart from said light incidence surface and said light emergent surface, said at least one body has at least one interface to an optically thinner medium, it being possible for said at least one body to be moved in position such that an incident angle of said light beam on said interface to be set to an angle that is smaller or greater than or equal to the critical angle of total reflection at said interface.

10. The device of claim 9, wherein said at least one body is assigned an actuator that permits a movement in position of said at least one body in such a way that said light beam can be incident on said interface at an incidence angle in the range of between 0° and the critical angle of total reflection.

11. The device of claim 9, wherein connected upstream of said at least one body is at least one of a polarizer and an element for rotating the polarization plane, which linearly polarizes said light beam entering through said light incidence surface parallel or perpendicular to said incidence plane.

12. The device of claim 9, wherein said at least one body can be rotated about an axis of rotation running transverse to the incidence plane of said light beam, and can be moved in a translatory fashion transverse to said axis of rotation.

13. The device of claim 9, wherein said at least one body can be rotated about an axis of rotation which runs transverse to the incidence plane of said light beam and is selected such that said light beam emerging from said light emergent surface does not vary, or scarcely varies, its spatial position relative to said light beam entering through said light incidence surface.

14. The device of claim 9, wherein said at least one body is a prism.

15. The device of claim 9, wherein said at least one body is a prism of constant deflection.

16. The device of claim 15, wherein said at least one body is a right-angled prism.

17. The device of claim 9, wherein said at least one body is a prism of constant deflection, and wherein said at least one body is a right-angled isosceles prism.

18. The device of claim 17, wherein said prism is made from a material with a refractive index of greater than or equal to 2^{0.5}.

19. The device of claim 9, wherein said light incidence surface is provided with at least one of an antireflection coating and an antireflection microstructure.

20. The device of claim 9, wherein said light incidence surface exhibits shaping of such type that said light incidence surface is arranged at the Brewster angle relative to said light beam entering through said light incidence surface.

21. The device of claim 9, wherein said interface is provided with at least one of a coating or microstructure for modifying the course of the curve of the reflection coefficient as a function of said incidence angle at said interface.

22. The device of claim 9, wherein said body consists of calcium fluoride.
